(19) United States
(12) Patent Application Publication
(10) Pub. No.: US 2021/0264242 A1
(43) Pub. Date: Aug. 26, 2021

(54) RAPID TIME-SERIES PREDICTION WITH HARDWARE-BASED RESERVOIR COMPUTER

(71) Applicant: Ohio State Innovation Foundation, Columbus, OH (US)

(72) Inventors: Daniel CANADAY, Columbus, OH (US); Daniel GAUTHIER, Hilliard, OH (US); Aaron GRIFFITH, Reynoldsburg, OH (US)

(21) Appl. No.: 17/255,033

(22) PCT Filed: Mar. 27, 2019
(86) PCT No.: PCT/US2019/024296

§ 371 Date: Dec. 22, 2020

Related U.S. Application Data
(60) Provisional application No. 62/690,698, filed on Jun. 27, 2018.

(51) Int. Cl. G06N 3/063; G06N 3/04; G06N 3/08

(52) U.S. Cl. CPC G06N 3/063; G06N 3/08; G06N 3/0445

(57) ABSTRACT

Reservoir computing systems and methods provide rapid processing speed by the reservoir and by the output layer. A hardware implementation of reservoir computing is based on an autonomous, time-delay, Boolean network realized on a readily-available platform known as a field-programmable gate array (FPGA). This approach allows for a seamless coupling of the reservoir to the output layer due to the spatially simple nature of the reservoir state and because matrix multiplication of a Boolean vector can be realized with compact Boolean logic. Embodiments may be used to predict the behavior of a chaotic dynamical system.

### CROSS-REFERENCE TO RELATED APPLICATIONS

This application claims the benefit of U.S. provisional patent application No. 62/690,698, filed on Jun. 27, 2018, and entitled “RAPID TIME-SERIES PREDICTION WITH AN FPGA-BASED RESERVOIR COMPUTER,” the disclosure of which is expressly incorporated herein by reference in its entirety.

### BACKGROUND

There is interest in the machine learning community in using recurrent neural networks (RNNs) for processing time-dependent signals. Under some mild assumptions, these types of networks are universal approximators of dynamical systems, similarly to how multilayer feedforward neural networks are universal approximators of static maps. Many machine learning and artificial intelligence tasks, such as dynamical system modeling, human speech recognition, and natural language processing are intrinsically time-dependent tasks, and thus are more naturally handled within a time-dependent, neural-network framework.

Though they have high expressive power, RNNs are difficult to train using gradient-descent-based methods. One approach to efficiently and rapidly train an RNN is known as reservoir computing (RC). Reservoir computing is a neural network approach for processing time-dependent signals that has seen rapid development in recent years. In RC, the network is divided into input nodes, a bulk collection of nodes known as the reservoir, and output nodes, such that the only recurrent links are between reservoir nodes. Training involves only adjusting the weights along links connecting the reservoir to the output nodes and not the recurrent links in the reservoir. This approach displays state-of-the-art performance in a variety of time-dependent tasks, including chaotic time-series prediction, system identification and control, and spoken word recognition, all with short training times in comparison to other neural-network approaches.

Thus, reservoir computers are well-suited for machine learning tasks that involve processing time-varying signals such as those generated by human speech, communication systems, chaotic systems, weather systems, and autonomous vehicles. Compared to other neural network techniques, reservoir computers can be trained using less data and in much less time. They also possess a large network component, called the reservoir, that can be re-used for different tasks.

Physical implementations of the RC technique using optical reservoirs have demonstrated high accuracy and processing speed at benchmark tasks. Recent implementations of reservoir computing using dedicated hardware have achieved much attention, particularly those based on delay-coupled photonic systems. These devices allow for reservoir computing at extremely high speeds, including the classification of spoken words at a rate of millions of words per second. There is also the potential to form the input and output layers using optics as well, resulting in an all-optical computational device. However, these devices are not well-equipped to handle tasks such as time-series prediction, which require the input and output layers to be coupled, where the output is fed back into the reservoir. For example, these approaches require rearrangement of the data injected into the reservoir, which causes delays in information processing. Often, this masking and the subsequent output-layer processing is done using an electronic device to maintain high performance, which limits their use in tasks such as time-series prediction at high speed.

### SUMMARY

Reservoir computing systems and methods provide rapid processing speed by the reservoir and by the output layer. A hardware implementation of reservoir computing is based on an autonomous, time-delay, Boolean network realized on a readily-available platform known as a field-programmable gate array (FPGA). This approach allows for a seamless coupling of the reservoir to the output layer due to the spatially simple nature of the reservoir state and because matrix multiplication of a Boolean vector can be realized with compact Boolean logic. Embodiments may be used to predict the behavior of a chaotic dynamical system, as well as training the reservoir to learn the short-term behavior and the long-term behavior of a chaotic system. Additionally, the fading memory property is satisfied by using low connectivity and threshold nodes.

In an implementation, a reservoir computing device is provided. The reservoir computing device includes an input layer configured to receive at least one input signal; a reservoir comprising a plurality of nodes, wherein at least one node of the plurality of nodes is coupled to the input layer to receive the at least one input signal, wherein the reservoir comprises an autonomous time-delay Boolean network; and an output layer configured to output at least one output signal, wherein at least another node of the plurality of nodes is coupled to the output layer, wherein the input layer, the reservoir, and the output layer are comprised in integrated circuitry.

In an implementation, a reservoir computing device is provided. The reservoir computing device includes a reservoir comprising an autonomous time-delay Boolean network of nodes; and a controller configured to provide input data to the reservoir and receive output data from the reservoir, wherein the reservoir and the controller are comprised in integrated circuitry and configured to provide time-series prediction.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is block diagram of an implementation of a reservoir computing device;

FIG. 2 is an illustration of an example reservoir computing device;

FIG. 3 is an operational flow of an implementation of a method of reservoir computing;

FIG. 4 is an illustration of another example reservoir computing device;

FIG. 5 is an operational flow of another implementation of a method of reservoir computing;

FIG. 6 is block diagram of another implementation of a reservoir computing device;

FIG. 7 is an illustration of a lookup table useful in explaining embodiments;

FIG. 8 is an illustration of example hardware description language for an implementation of a node;

FIG. 9 is an illustration of example hardware description language for an implementation of a delay line;

FIG. 10 is an illustration of example hardware description language describing an implementation of a reservoir;

FIG. 11 is an illustration of example hardware description language describing an implementation of a reservoir computer; and

FIG. 12 shows an exemplary computing environment in which example embodiments and aspects may be implemented.

### DETAILED DESCRIPTION

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

A reservoir computing device comprising an autonomous, time-delay, Boolean network configured on a field-programmable gate array (FPGA) is described. Such devices allow for complex networks consisting of thousands of nodes with an arbitrary network topology. Time-delays can be incorporated along network links, thereby allowing for extremely high-dimension reservoirs. The characteristic time scale of a network node is less than a nanosecond, allowing for information processing in the GHz regime. Furthermore, because the reservoir state is Boolean rather than real-valued, the calculation of an output from the reservoir state can be done rapidly with synchronous FPGA logic. Such a reservoir computing device may be used to forecast the dynamics of a chaotic system.

The logic elements in the reservoir are autonomous, meaning that the logic is not regulated by a global clock. When the logic is clocked, a software simulation of a reservoir computer is effectively obtained. The autonomous logic has a potential to go beyond what any standard computer simulation can do. Moreover, delay elements are incorporated between the network nodes in the reservoir to match the time scale of the reservoir with the time scale of the data injected into the reservoir. This is relevant for autonomous nodes.

As described further herein, a neural network technique known as reservoir computing is used. In this technique, a mapping from a time-dependent input signal u(t) to a desired output signal v_{d}(t) is formed by (1) creating a randomly connected, recurrent network of nodes, (2) exciting the network with u(t) over some training period, and (3) training a readout layer that maps the network state v_{d}(t). Reservoir computing demonstrates state-of-the-art performance at a number of time-dependent machine learning tasks, such as time-series prediction. Additionally, training can be done in seconds to minutes, compared to days with deep-learning techniques.

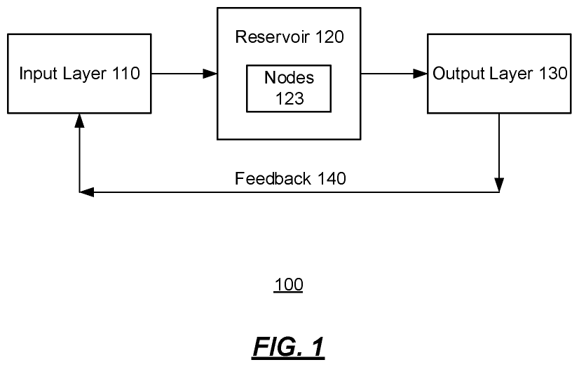

FIG. 1 is block diagram of an implementation of a reservoir computing device 100. The reservoir computing device 100 comprises an input layer 110, a reservoir 120, an output layer 130, and feedback 140. The input layer 110 provides one or more input signals (e.g., u(t)) to the reservoir 120. The input signals can be weighted using values determined during training of the reservoir computing device 100. The input layer 110 may comprise a plurality of input channels that carry input signals.

The reservoir 120 may be a recurrent artificial neural network comprising a plurality of nodes 123. The reservoir 120 may contain interconnections that couple a pair of the nodes 123 together in the reservoir 120, such that one of the nodes 123 provides its output as an input to another of the nodes 123. Each of the nodes 123 may be weighted with a real-valued weight. The nodes 123 in the reservoir 120 may implement one or more logic gates, such as Boolean logic gates, to perform various operations on input signals from the input layer 110. The input layer 110 may be coupled to some or all of the nodes 123 (e.g., an input node subset of the nodes 123) depending on the implementation. Results from the nodes 123 may be provided from the reservoir 120 to the output layer 130. The output layer 130 may be coupled to some or all of the nodes 123 (e.g., an output node subset of the nodes 123). According to some aspects, the reservoir 120 may be implemented in integrated circuitry, such as an FPGA.

In an embodiment, the reservoir 120 is realized by an autonomous, time-delay, Boolean network configured on an FPGA. Together with the parallel nature of the network, this allows for up to ten times faster information processing than delay-coupled photonic devices.

The output layer 130 may receive output signals from the reservoir 120. The output layer 130 may comprise a plurality of output channels that carry output signals. Weights may be added to the output signals in the reservoir 120 before being provided to the output layer 130 (e.g., as v_{d}(t)). The weights may be determined during training of the reservoir computing device 100. Weights may also be applied to the input signals of the input layer 110 before being provided to the reservoir 120.

The feedback 140 may be comprised of feedback circuitry and/or feedback operations in which the output signal of the device 100 (i.e., the output of the output layer 130) is sent back to the input layer 110 to create feedback within the reservoir 120.

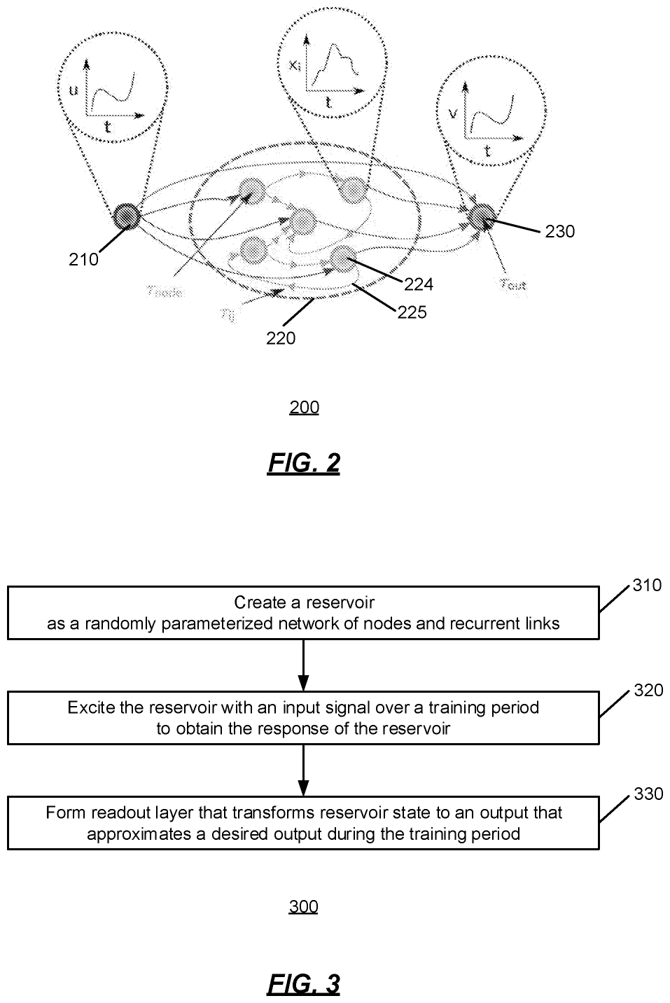

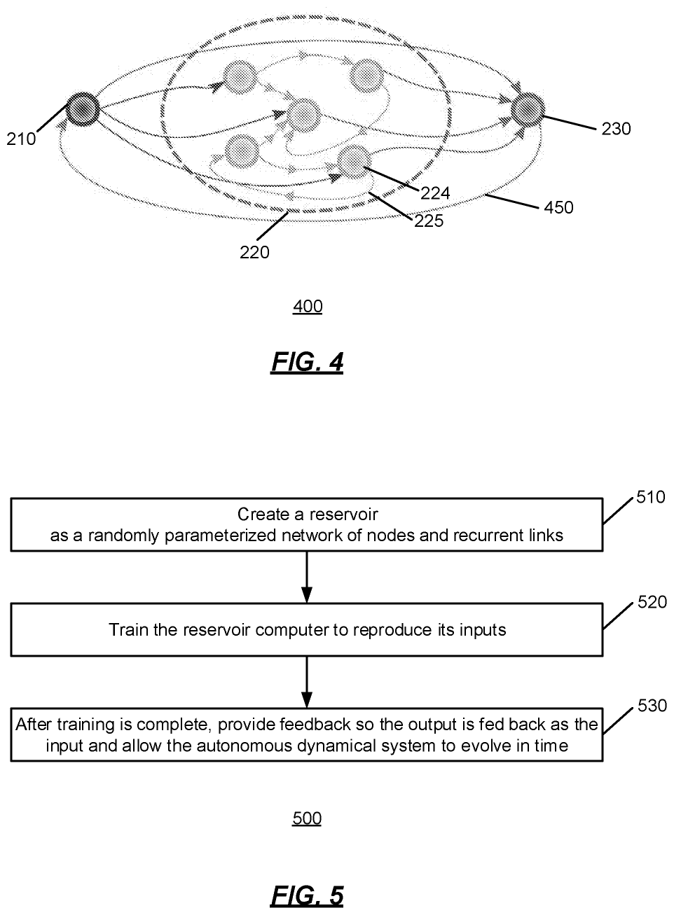

FIG. 2 is an illustration of an example reservoir computing device 200, and FIG. 3 is an operational flow of an implementation of a method 300 of reservoir computing. The device 200 comprises an input node 210 (or input layer), a reservoir 220 comprising a plurality of nodes 224, and an output node 230 (or output layer). Also shown are a plurality of links 225 between various ones of the input node 210, the nodes 224, and the output node 230. Given an input signal u(t) at the input node 210, and a desired output signal v_{d}(t) at the output node 230, a reservoir computer constructs a mapping from u(t) to v_{d}(t) with the following steps.

At 310, create a randomly parameterized network of nodes and recurrent links called the reservoir with state X(t) and dynamics described by \dot{X}(t)=f[X(t),u(t)]. At 320, excite the reservoir with an input signal u(t) over some training period and observe the response of the reservoir. At 330, form a readout layer that transforms the reservoir state X(t) to an output v(t), such that v(t) well approximates v_{d}(t) during the training period.

No assumptions are made about the dynamics f. In general, it may include discontinuities, time-delays, or have components simply equal to u(t) (i.e., the reservoir 220 may include a direct connection from the input 210 to the output 230).

Thus, in FIG. 2, a general reservoir computer learns to map an input onto a desired output. The network dynamics may contain propagation delays along the links (denoted by τᵢⱼ) or through nodes (such as through the output layer, denoted by τₒᵤₜ).

Reservoir computing demonstrates remarkable success at predicting a chaotic time-series, among other applications. The goal of this task is to predict the output of an unknown dynamical system after a training period. In the context of RC, this is accomplished by setting v_{d}(t)=u(t), i.e., by training the reservoir computer to reproduce its inputs, and then allowing the newly-formed autonomous system to evolve in time beyond the end of the training period.

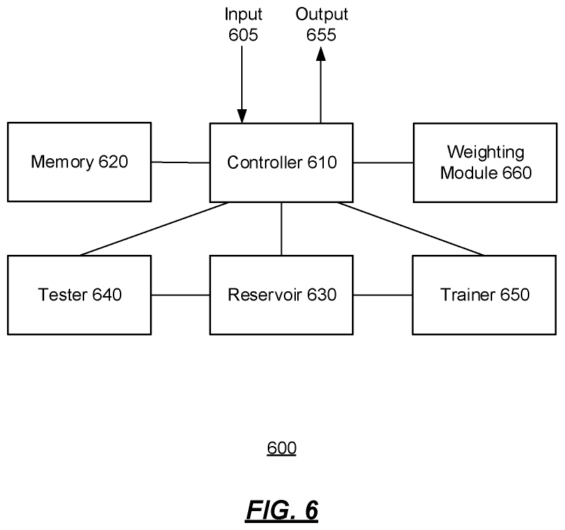

FIG. 4 is an illustration of another example reservoir computing device 400. This closed-loop system is illustrated in FIG. 4 and consists of the same components as in FIG. 2, but the input and output are the same signal. This technique can predict accurately the short-term behavior of a variety of systems, including the Mackey-Glass, Lorenz, and Kuramoto-Sivashinsky spatial-temporal systems using a software simulation of the reservoir. A reservoir computer trained in this manner can also learn the long-term behavior of complex systems, generating the true attractor of the target system and replicating its Lyapunov spectrum.

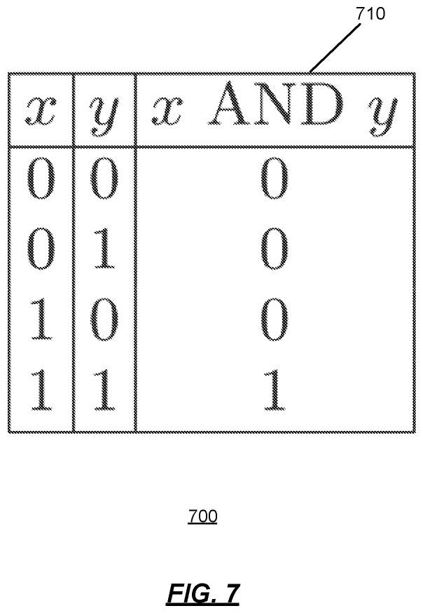

FIG. 5 is an operational flow of another implementation of a method 500 of reservoir computing. At 510, similar to 310, create a randomly parameterized network of nodes and recurrent links called the reservoir with state X(t) and dynamics described by \dot{X}(t)=f[X(t),u(t)]. At 520, the reservoir computer is trained to reproduce its inputs. Thus, for the particular task of predicting a signal, the reservoir is trained so that the target output is equal to the input. At 530, after training is complete, feedback is provided so that the output is fed back as the input. Thus, after training, the output is fed back into the reservoir, resulting in an autonomous dynamical system. If properly trained, the autonomous reservoir serves as a model for the dynamics that generated the input signal.

FIG. 6 is block diagram of another implementation of a reservoir computing device 600. The reservoir computing device 600 can receive an input 605, such as input u(t) from a memory 620 or a computing device such as the computing device 1200 described with respect to FIG. 12. Depending on the implementation, the memory 620 may be comprised within, or in communication with, the reservoir computing device 600, comprised within the computing device 1200, or other suitable memory or storage device. In an embodiment, the device 600 may comprise an FPGA, with each component of the device 600 being implemented in the FPGA, although this is not intended to be limiting, as other implementations are contemplated, such as an Application Specific Integrated Circuit (ASIC), for example.

In an implementation, a controller 610 may store data to and/or retrieve data from the memory 620. The data may include the input 605, an output 655, and node data of a reservoir 630. Data associated with testing and training may also be provided to and from the controller 610 to and from a tester 640 and a trainer 650, respectively. The controller 620 may be configured to apply weighting to the input 605 and/or the output prior to being provided as the output 655. The weightings may be generated by a weighting module 660, provided to the controller 610, and applied to the various signals by the controller 610.

The reservoir 630 may process the input 605 and generate the output 655. In some embodiments, output from the reservoir 630 may be weighted by the controller 610. The controller 610 may then provide this weighted output of the reservoir 630 as the output 655.

Although training the network consists only of identifying optimal parameters in the readout layer, several factors may be considered in designing the reservoir. These factors are now described.

In general, both the reservoir and the source of the signal u(t) are dynamical systems with their own characteristic time scales. These time scales are similar for the reservoir to produce v(t). For software-based approaches to RC, these scales are matched by tuning the reservoir's temporal properties through accessible reservoir parameters, such as the response time τ_{node} (e.g., see FIG. 2) of reservoir nodes. However, with hardware-based approaches, the parameters controlling the time scale of reservoir dynamics are often more rigid. This may be compensated for by adjusting the time scale of the input signal and/or adding delays to the links within the reservoir.

It has been determined that an effective reservoir for RC is a system that possesses fading memory. That is, the reservoir state contains information about the input signal u(t), but the effect of small differences in u(t) dissipates over time. This is often referred to as the echo-state property. The autonomous reservoirs disclosed herein have the fading memory property. Furthermore, the characteristic time scale over which small differences dissipate can be tuned by adding delays to the links within the reservoir.

Each RC implementation couples u(t) to the reservoir in a technique-dependent way, such as spike-encoding in liquid state machines (LSMs) or by consideration of so-called “virtual nodes” in photonic reservoirs. The coupling in the FPGA-based approach described herein is complicated by the fact that nodes execute Boolean functions, whereas the input signal u(t) is a large-bit representation of a real number. Consider, as with most techniques for processing physical data, the limited precision and sampling rate of the input signal. The sampling rate is particularly relevant for a physical reservoir computer, as the reservoir nodes have their own, fixed characteristic time scale.

In software-based reservoir computing schemes, the readout layer performs its operation effectively instantaneously as far as the simulation is concerned. However, this is not possible when the reservoir is a continuously evolving physical system. There is a finite time required to calculate v(t), which can be interpreted as a propagation delay τₒᵤₜ (e.g., see FIG. 2) through the readout layer and ultimately limits the rate at which predictions can be made in closed-loop operation. Consequently, v(t) is calculated from a measurement of X(t−τₒᵤₜ) for the predicted output to be ready to be fed back into the input at time t.

The hardware implementation of RC described herein provides a minimal output delay so that predictions can be made as rapidly as possible.

In an embodiment, an autonomous Boolean reservoir is used. More particularly, the reservoir is an autonomous, time-delay, Boolean reservoir realized on an FPGA. By forming the nodes of the reservoir from FPGA elements themselves, this approach exhibits faster computation than FPGA-accelerated neural networks which require explicit multiplication, addition, and non-linear transformation calculations at each time-step. This implementation also has the advantage of realizing the reservoir and the readout layer on the same platform without delays associated with transferring data between different hardware. Additionally, due to the Boolean-valued state of the reservoir, a linear readout layer, v(t)=WₒᵤₜX(t), is reduced to an addition of real numbers rather than a full matrix multiplication. This allows for much shorter total calculation time and thus faster real-time prediction than in opto-electronic RC.

It is noted that Boolean networks with time-delay can exhibit complex dynamics, including chaos. In fact, a single XOR node with delayed feedback can exhibit a fading memory condition and is suitable for RC on simple tasks such as binary pattern recognition. It has been proposed that individual FPGA nodes have dynamics that can be described by the Glass model given by

γᵢ\dot{x}ᵢ=−xᵢ+Λᵢ(Xᵢ₁,Xᵢ₂, . . . ) (1)

Xᵢ=1 if xᵢ≥qᵢ;0 if xᵢ<qᵢ (2)

where xᵢ is the continuous variable describing the state of the node, γᵢ describes the time scale of the node, qᵢ is a thresholding variable, and Λᵢ is the Boolean function assigned to the node. The thresholded Boolean variable Xᵢⱼ is the j-th input to the i-th node.

The Boolean reservoir is constructed by forming networks of nodes described by Eqs. (1) and (2) and the Boolean function

Λᵢ=Θ(ΣⱼW^{ij}Xⱼ+Wᵢₙ^{ij}uⱼ) (3)

where uⱼ are the bits of the input vector u, W is the reservoir-reservoir connection matrix, Wᵢₙ is the input-reservoir connection matrix, and Θ is the Heaviside step function defined by

Θ(x)=1 if x>0;0 if x≤0 (4).

The matrices W and Wᵢₙ are chosen as follows. Each node receives the input from exactly k other randomly chosen nodes, thus determining k non-zero elements of each row of W. The non-zero elements of W are given a random value from a uniform distribution between −1 and 1. The maximum absolute eigenvalue (spectral radius) of the matrix W is calculated and used to scale W such that its spectral radius is ρ. A proportion σ of the nodes are chosen to receive input, thus determining the number of non-zero rows of Wᵢₙ. The nonzero values of Wᵢₙ are chosen carefully, but note that the scale of Wᵢₙ does not need to be tuned, as it is apparent from Eq. (3) that only the relative scale of W and Wᵢₙ determines Λᵢ.

The three parameters defined above, k, ρ, and σ, are the three hyperparameters that characterize the topology of the reservoir. The parameter τ̅ characterizes delays introduced along links between nodes. Together, these four hyperparameters describe the reservoirs.

The presence of the −xᵢ term in Eq. (1) represents the sluggish response of the node, i.e., its inability to change its state instantaneously. This results in an effective propagation delay of a signal through the node. To take advantage of this phenomenon, delays are created by connecting chains of pairs of inverter gates between nodes. These inverter gates have dynamics described by Eqs. (1) and (2) and

λᵢ(X)=0 if X=1;1 if X=0 (5).

Note that the propagation delay through these nodes depends both on γᵢ and qᵢ, both of which are heterogeneous throughout the chip due to small manufacturing differences. The mean propagation delay through the inverter gates is denoted by τᵢₙᵥ, which is measured by recording the oscillation frequencies of variously sized loops of these gates.

Exploit the propagation delays by inserting chains of pairs of inverter gates in between reservoir nodes, thus creating a time-delayed network. Set the mean delay τ̅ and randomly choose a delay time for each network link. This is similar to how the network topology is chosen by fixing certain hyperparameters and randomly choosing W and Wᵢₙ subject to these parameters. The random delays are chosen from a uniform distribution between τ̅/2 and 3τ̅/2 so that delays on the order of τ_{node} are avoided.

The addition of these delay chains is useful because the time scale of individual nodes is much faster than the speed at which synchronous FPGA logic can change the value of the input signal. Without any delays, it is impossible to match the time scales of the input signal with the reservoir state, resulting in poor RC performance. The time scales associated with the reservoir's fading memory are controlled by τ̅, thus demonstrating that the reservoir's time scales can be tuned with delay lines.

For the reservoir to learn about its input sequence, it will possess the fading memory property (although more may be required for replicating long-term behavior). Intuitively, this property implies that the reservoir state X(t) is a function of its input history, but is more strongly correlated with more recent inputs. More precisely, the fading memory property states that every reservoir state X(t₀) is uniquely determined by a left-infinite input sequence {u(t):t<t₀}.

The fading memory property is equivalent to the statement that, for any two reservoir states X₁(t₀) and X₂(t₀) and input signal {u(t):t>t₀},

$${lim}_{t \to ∞} {‖ {X}_{1} ( t ) - {X}_{2} ( t ) ‖}_{2} = 0. \qquad ( 6 )$$

Also of interest is the characteristic time scale over which this limit approaches zero, which may be understood as the Lyapunov exponent of the coupled reservoir-input system conditioned on the input.

Observe the fading memory property and measure the corresponding time scale with the following procedure. Prepare two input sequences {u₁(iΔt); −N≤i≤N} and {u₂(iΔt); −N≤i≤N}, where Δt is the input sample and N is an integer such that NΔt is sufficiently large. Each u₁(iΔt) is drawn from a random, uniform distribution between −1 and 1. For i≥0, u₂(iΔt)=u₁(iΔt). For i<0, u₂(iΔt) is drawn from a random, uniform distribution between −1 and 1. Drive the reservoir with the first input sequence and observe the reservoir response {X₁(iΔt); −N≤i≤N}. After the reservoir is allowed to settle to its equilibrium state, drive it with the second input sequence and observe {X₂(iΔt); −N≤i≤N}. The reservoir is perturbed to effectively random reservoir states X₁(0) and X₂(0), because the input sequences are unequal for i<0. For i≥0, the input sequences are equal, and the difference in Eq. (6) can be calculated.

For a given reservoir, this procedure is repeated 100 times with different input sequences. For each pair of sequences, the state difference is fit to exp(−t/λ), and the λ's are averaged over all 100 sequences. λ is referred to as the reservoir's decay time, and has a linear dependence on hyperparameter τ̅, with the relationship being approximately linear for fixed k, ρ, and σ. This is consistent with τ̅ being the dominate time scale of the reservoir rather than τ_{node}, which is a motivation for including delay lines in the reservoir construction.

The reservoir implementation is an autonomous system without a global clock, allowing for continuously evolving dynamics. However, the input layer is a synchronous FPGA design that sets the state of the input signal u(t). Prior to operation, a sequence of values for u(t) is stored in the FPGA memory blocks. During the training period, the input layer sequentially changes the state of the input signal according to the stored values.

For the prediction task, the stored values of u(t) are observations of some time-series from t=−Tₜᵣₐᵢₙ to t=0. This signal maybe defined on the entire real interval [−Tₜᵣₐᵢₙ, 0], but only a finite sampling may be stored in the FPGA memory and presented as the input to the reservoir. The signal may also take real values, but only a finite resolution at each sampling interval may be stored. The actual input signal u(t) is thus discretized in two ways: u(t) is held constant along intervals of length tₛₐₘₚₗₑ, and u(t) is approximated by an n-bit representation of real numbers.

It is noted that tₛₐₘₚₗₑ may be no smaller than the minimum time in which the clocked FPGA logic can change the state of the input signal. However, it has been determined that tₛₐₘₚₗₑ is preferably greater than or equal to τₒᵤₜ.

The Boolean functions described by Eqs. (3) and (4) are defined according to Boolean values uⱼ, which are the bits in the n-bit representation of the input signal. If the elements of Wᵢₙ are drawn randomly from a single distribution, then the reservoir state is as much affected by the least significant bit of u(t) as it is the most significant. This leads to the reservoir state being distracted by small differences in the input signal and fails to produce a working reservoir computer.

For a scalar input u(t), correct this shortcoming by choosing the rows of Wᵢₙ such that

ΣⱼWᵢₙ^{i,j}uⱼ≈\tilde{W}ᵢₙⁱu (7)

where \tilde{W}ᵢₙ is an effective input matrix with non-zero values drawn randomly between 1 and −1. The relationship is approximate in the sense that u is a real-number and uⱼ is a binary representation of that number. For the two complement representations, this is done by choosing

Wᵢₙ^{i,j}=−2⁽ⁿ⁻¹⁾\tilde{W}ᵢₙⁱ if j=n;else=+2^{(j-1)}\tilde{W}ᵢₙⁱ (8).

A disadvantage of such an implementation is that every bit in the representation of u must go to every node in the reservoir. If a node has k recurrent connections, then it must execute a n+k to 1 Boolean function, as can be seen from Eq. (3). Boolean functions with more inputs take more FPGA resources to realize in hardware, and it takes more time for a compiler to simplify the function. It has been determined that an 8-bit representation of u is sufficient for the prediction task described here while maintaining achievable networks.

Similar to the input layer, the output layer is constructed from synchronous FPGA logic. Its function is to observe the reservoir state and, based on a learned output matrix Wₒᵤₜ, produce the output v(t). This operation uses a time τₒᵤₜ that is considered to be a propagation delay through the output layer and, as such, v(t) is calculated from X(t−τₒᵤₜ).

For the time-series prediction task, the desired reservoir output v_{d}(t) is just u(t). The input signal is discretized both in time and in precision. Thus, v(t) is discretized in the same fashion. Note that because the reservoir state X(t) is Boolean valued, a linear transformation Wₒᵤₜ of the reservoir state is equivalent to a partial sum of the weights Wₒᵤₜ, where Wₒᵤₜⁱ is included in the sum only if Xᵢ(t)=1.

The inclusion of a direct connection greatly improves prediction performance. Though this involves a multiplication of 8-bit numbers, it only slightly increases τₒᵤₜ because this multiplication can be done in parallel with the calculation of the addition of the Boolean reservoir state.

With the above considerations in mind, the output layer is constructed as follows: on the rising edge of a global clock with period t_{global}, the reservoir state is passed to a register in the output layer. The output layer calculates WₒᵤₜX with synchronous logic and in one clock cycle, where the weights Wₒᵤₜ are stored in on-board memory blocks. The calculated output v(t) is passed to a register on the edge of the global clock. If t>0, i.e., if the training period has ended, the input layer passes v(t) to the reservoir rather than the next stored value of u(t).

For v(t) to have the same discretized form as u(t), the global clock period t_{global} is set equal to the input period tₛₐₘₚₗₑ, which means the fastest the reservoir computer can produce predictions is once every max{τₒᵤₜ, tₛₐₘₚₗₑ}. While tₛₐₘₚₗₑ is independent of the size of the reservoir and precision of the input, τₒᵤₜ depends on both.

The reservoir computer, including the autonomous reservoir and the synchronous input and output layers, may be used to predict a chaotic time-series. To quantify the performance of the prediction algorithm, compute the normalized root-mean-square error (NRMSE) over one Lyapunov time T, where T is the inverse of the largest Lyapunov exponent. The NRMSE_{T} is therefore defined as

$$NRMS {E}_{T} = \sqrt{\frac{{\sum }_{t = 0}^{T} {[ u ( t ) - v ( t ) ]}^{2}}{T {σ}^{2}}} \qquad ( 9 )$$

where σ² is the variance of u(t).

To train the reservoir computer, the reservoir is initially driven with the stored values of u(t) and the reservoir response is recorded. This reservoir response is then transferred to a host PC. The output weights Wₒᵤₜ are chosen to minimize

Σ_{t=-T}_{ₜᵣₐᵢₙ}⁰[u(t)−v(t)]²r|Wₒᵤₜ|² (10)

where r is the ridge regression parameter and is included in Eq. (6) to discourage over-fitting to the training set. The value of r is chosen by leave-one-out cross validation on the training set.

An implementation of hardware description code for the reservoir nodes, delay lines, and a small reservoir is provided. The example code herein is written in Verilog (a hardware description language (HDL) used to configure and model electronic systems) and compiled using Altera's Quartus Prime software. Some parts of the hardware description language depend on the number of reservoir nodes N, the node in-degree k, and the number of bits n used to represent the input signal u(t). The hardware description language is provided herein for N=3, k=2, and n=1, but generalizations are straightforward.

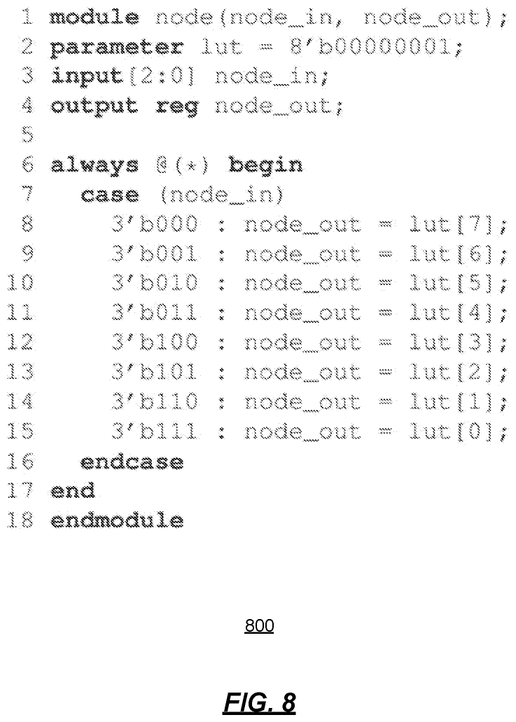

As discussed further herein, reservoir nodes implement a Boolean function λᵢ: Z₂^{k+n}→Z₂ of the form given in Eq. (3). Each Boolean function can be defined by a Boolean string of length 2^{k+n} that specifies the lookup-table (LUT) corresponding of the Boolean function. For example, the “and” function maps Z₂²→Z₂ and has the LUT defined in FIG. 7. FIG. 7 is an illustration of a lookup table 700 for the “and” function that is useful in explaining embodiments. The “and” function can be specified by the Boolean string that makes up the column 710. The Boolean string that defines the “and” function is 0001 as can be seen from the column 710 of the LUT 700.

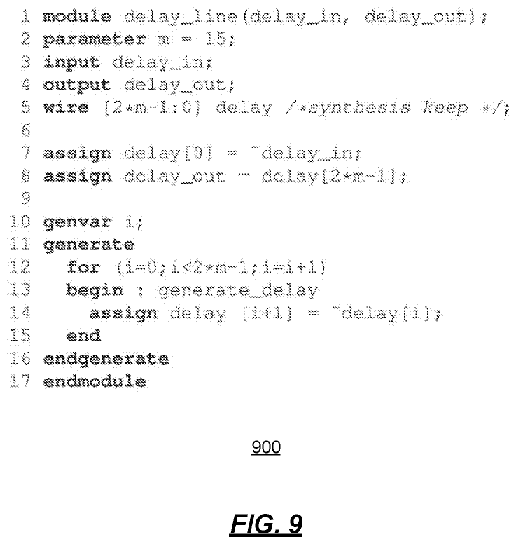

FIG. 8 is an illustration of example hardware description language 800 for an implementation of a node. FIG. 8 shows Verilog hardware description language for a generic node that can implement any 3-input Boolean function, specified by a Boolean string of length 8. The hardware description language given in FIG. 8 generates a node with Boolean function based on any LUT of length 2³=8. The module node is declared in line 1 with inputs node_in and output node_out. The width of node_in is 3 bits as specified in line 3. The parameter lut is declared in line 2. Note that it is initialized to some value as required by Quartus, but this value is changed whenever a node is declared within the larger hardware description language that defines the complete reservoir.

The main part of the hardware description language is within an always @(*) block, which creates an inferred sensitivity list and is used to create arbitrary combinational logic. Line 7 specifies that values before the colon in the proceeding lines correspond to node_in. The statement following the colon determines which value is assigned to node_out. In effect, line 8 specifies that, whenever the value of node_in is a 3-bit string equal to 000, the value of node_out is whatever the value of lut[7] is. For example, if an instance of the module node is created with parameter lut=8′b00000001, then the node will execute the 3 input and function.

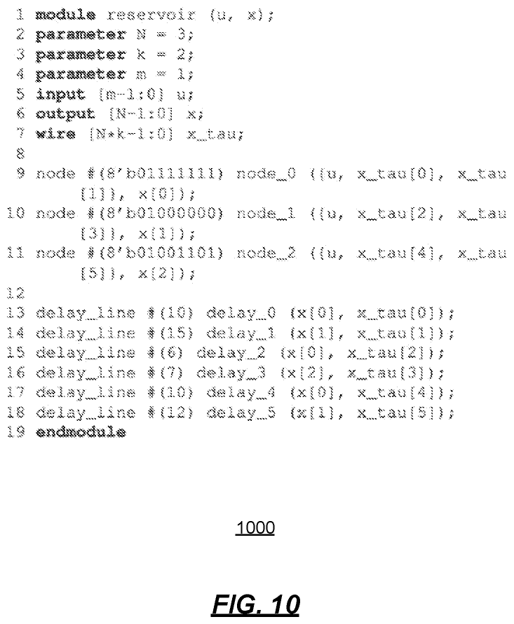

Delay lines are created as chains of pairs of inverter gates. Such a chain of length 2 m is created with the hardware description language in FIG. 9. FIG. 9 is an illustration of example hardware description language 900 for an implementation of a delay line. FIG. 9 shows Verilog hardware description language for a delay line with 2 m inverter gates. Similarly to the node module, the delay_line module is declared in line 1 with the input delay_in and output delay_out. It has a parameter m which specifies the number of pairs in the chain and can be changed when calling a specific instance of delay_line. A number of wires are declared in line 5 and will be used as the inverter gates. Note the directive /*synthesis keep*/, which instructs the compiler to not simplify the module by eliminating the inverter gates. This is used because otherwise the compiler would realize that delay_line's function is trivial and remove all of the inverter gates.

Lines 7-8 specify the beginning and end of the delay chain as the delay_in and delay_out, respectively. Lines 10-16 use a generate block to create a loop that places inverter gates in between delay_in and delay_out, resulting in a delay chain of length 2 m.

The reservoir module is the hardware description language that creates N instances of node and connects them Nk instances of delay_line. As an illustrative example, consider a 3-node reservoir with the following parameters

$$\begin{matrix}W = [ \begin{matrix}0.1 & 0.3 & 0 \\ - 0.2 & 0 & 0.1 \\ - 0.3 & 0.2 & 0\end{matrix} ] & ( A1 ) \\ {W}_{i n} = [ \begin{matrix}0.1 \\ - 0.2 \\ 0.2\end{matrix} ] & ( A2 ) \\ τ = [ \begin{matrix}10 & 15 & 0 \\ 6 & 0 & 7 \\ 12 & 10 & 0\end{matrix} ] & ( A3 )\end{matrix}$$

and only a 1-bit representation of u(t). When u(t) and x(t) are passed into the node module, index such that u(t) comes first, as seen from the reservoir module below.

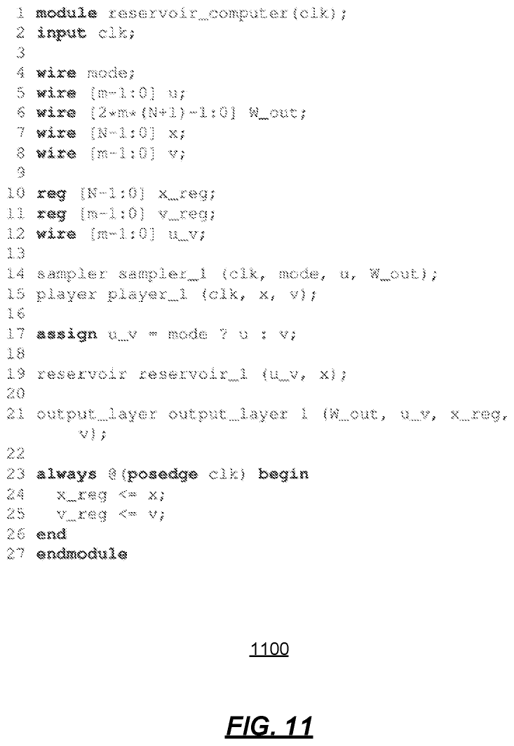

With Eqs. (3) and (A1)-(A3), the LUTs for each node can be explicitly calculated as 01111111, 0100000000, and 01001101 for nodes 1-3, respectively. The matrix τ specifies the delays in integer multiples of 2τᵢₙᵥ. A network with this specification is realized by the module reservoir in FIG. 10 and the node and delay_in modules described herein.

FIG. 10 is an illustration of example hardware description language 1000 describing an implementation of a reservoir (i.e., Verilog hardware description language describing a simple reservoir). The connections and LUTs are determined from Eqs. (3) and (A1)-(A3). Lines 9-11 declare three nodes. Lines 13-18 declare delay lines that connect them.

Thus, like the other modules, reservoir requires a module declaration, parameter declarations, and input/output declarations. Here, declare a wire x_tau that is the delayed reservoir state. In lines 9-11, the nodes are declared with the appropriate parameters and connections and are named node_0, node_1, and node_2, respectively. The six delay lines are declared and named in lines 13-18.

Synchronous components that interact with the autonomous reservoir regulate the reservoir input signal, the operation mode (training or autonomous), the calculation of the output signal, and record the reservoir state.

A sampler module reads data from the reservoir and a player module writes data into the reservoir. The details of these modules are not discussed here as they depend on the device and the application of the reservoir computer. These modules are synchronized by a global clock clk such that sampler (player) reads (writes) data on the rising edge of clk.

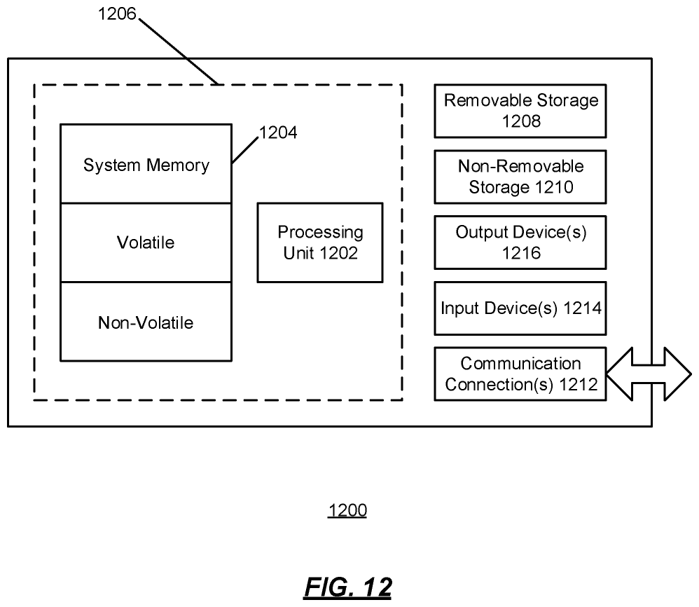

FIG. 11 is an illustration of example hardware description language 1100 describing an implementation of a reservoir computer. FIG. 11 contains the reservoir module discussed above and various synchronous components. FIG. 11 shows sample Verilog hardware description language for a high level module reservoir_computer containing the reservoir and synchronous components. An instance of a sampler module is coupled to a global clock clk and outputs an m-bit wide signal u, a 1 bit signal mode that determines the mode of operation for the reservoir, and a 2 m(N+1)-bit wide signal W_out that determines the output weight matrix. An instance of a player module is also coupled to a global clock clk and inputs an N-bit wide signal x and a m-bit wide signal v. Depending on how these modules are implemented, they may also be coupled to other components, such as on-board memory or other FPGA clocks.

In line 17, the state of mode determines whether u or v drives the reservoir. This bit is set to 1 during training and set to 0 after training to allow the reservoir to evolve autonomously. clk registers x and v so that output_layer sees a value of x that is constant throughout one period tₛₐₘₚₗₑ and outputs a value v that is constant over that same interval. The module output_layer performs the operation Wₒᵤₜ(x, u), as described above. W_out is a flattened array of the N+1 output weights represented by 2 m bits, with the extra bits being used to avoid errors in the intermediate addition calculations.

Thus, embodiments include a reservoir computer where the recurrent neural network is an autonomous, time-delay, Boolean network. This network can be readily realized on a field-programmable gate array. This choice of neural network has the advantages that (1) the network state is Boolean and therefore the map from the network state to the desired signal can be done extremely rapidly and (2) the readout layer can be done on the same hardware as the network, eliminating delays associated with the transfer of data between hardware. These advantages allow for the prediction of a time-series at extremely high speed, such as predictions at a rate of 160 MHz on an Intel/Altera Arria® 10 FPGA. Although the Intel/Altera Arria® 10 FPGA and aspects of its associated hardware description language are described with respect to some implementations, this is not intended to be limiting, as FPGAs and other devices, as well as associated hardware description languages, from many companies and vendors are contemplated and may be used depending on the particular implementation.

Implementations have industry application where it is desired to know the future state of an unknown or a partially unknown system that evolves on a nanosecond to microsecond time scale. Examples of such systems include analyzing radio frequency signals, realizing cryptographic radio-frequency coding and decoding systems, and behavior of high-frequency nano- or micro-scale devices.

FIG. 12 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 12, an exemplary system for implementing aspects described herein includes a computing device, such as computing device 1200. In its most basic configuration, computing device 1200 typically includes at least one processing unit 1202 and memory 1204. Depending on the exact configuration and type of computing device, memory 1204 may be volatile (such as random access memory (RAM)), non-volatile (such as read-only memory (ROM), flash memory, etc.), or some combination of the two. This most basic configuration is illustrated in FIG. 12 by dashed line 1206.

Computing device 1200 may have additional features/functionality. For example, computing device 1200 may include additional storage (removable and/or non-removable) including, but not limited to, magnetic or optical disks or tape. Such additional storage is illustrated in FIG. 12 by removable storage 1208 and non-removable storage 1210.

Computing device 1200 typically includes a variety of computer readable media. Computer readable media can be any available media that can be accessed by the device 1200 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1204, removable storage 1208, and non-removable storage 1210 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1200. Any such computer storage media may be part of computing device 1200.

Computing device 1200 may contain communication connection(s) 1212 that allow the device to communicate with other devices. Computing device 1200 may also have input device(s) 1214 such as a keyboard, mouse, pen, voice input device, touch input device, etc. Output device(s) 1216 such as a display, speakers, printer, etc. may also be included. All these devices are well known in the art and need not be discussed at length here.

In an implementation, a reservoir computing device comprises an input layer configured to receive at least one input signal; a reservoir comprising a plurality of nodes, wherein at least one node of the plurality of nodes is coupled to the input layer to receive the at least one input signal, wherein the reservoir comprises an autonomous time-delay Boolean network; and an output layer configured to output at least one output signal, wherein at least another node of the plurality of nodes is coupled to the output layer, wherein the input layer, the reservoir, and the output layer are comprised in integrated circuitry.

Implementations may include some or all of the following features. The integrated circuitry comprises a field-programmable gate array (FPGA). The reservoir computing device further comprises feedback from the output layer to the input layer, wherein an output signal of the output layer is an input signal to the input layer. The input layer, the reservoir, and the output layer are configured to predict a behavior of a chaotic dynamical system. The reservoir comprises a randomly parameterized network of nodes and recurrent links. The autonomous time-delay Boolean network comprises a plurality of autonomous logic elements. The reservoir is a recurrent artificial neural network. The reservoir comprises a plurality of interconnections, wherein each interconnection of the plurality of interconnections couples a pair of the plurality of the nodes. The at least one input signal is weighted. The at least one output signal is weighted. Each of the plurality of nodes is weighted. The plurality of nodes implements at least one Boolean logic gate to perform at least one operation on the at least one input signal.

In an implementation, a reservoir computing device comprises a reservoir comprising an autonomous time-delay Boolean network of nodes; and a controller configured to provide input data to the reservoir and receive output data from the reservoir, wherein the reservoir and the controller are comprised in integrated circuitry and configured to provide time-series prediction.

Implementations may include some or all of the following features. The integrated circuitry comprises a field-programmable gate array (FPGA). The reservoir computing device further comprises a memory that stores the input data, the output data, and node data of the autonomous time-delay Boolean network of nodes. The reservoir computing device further comprises a weighting module that applies weight to at least one of the input data, the output data, or the node data. The reservoir, the controller, the memory, and the weighting module are configured to predict a behavior of a chaotic dynamical system. The reservoir comprises a randomly parameterized network of nodes and recurrent links. The autonomous time-delay Boolean network comprises a plurality of autonomous logic elements. The reservoir comprises a plurality of interconnections, wherein each interconnection of the plurality of interconnections couples a pair of the nodes.

It should be understood that the various techniques described herein may be implemented in connection with hardware components or software components or, where appropriate, with a combination of both. Illustrative types of hardware components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A reservoir computing device, comprising:
an input layer configured to receive at least one input signal;
a reservoir comprising a plurality of nodes, wherein at least one node of the plurality of nodes is coupled to the input layer to receive the at least one input signal, wherein the reservoir comprises an autonomous time-delay Boolean network; and
an output layer configured to output at least one output signal, wherein at least another node of the plurality of nodes is coupled to the output layer,
wherein the input layer, the reservoir, and the output layer are comprised in integrated circuitry.

2. The reservoir computing device of claim 1, wherein the integrated circuitry comprises a field-programmable gate array (FPGA).

3. The reservoir computing device of claim 1, further comprising feedback from the output layer to the input layer, wherein an output signal of the output layer is an input signal to the input layer.

4. The reservoir computing device of claim 3, wherein the input layer, the reservoir, and the output layer are configured to predict a behavior of a chaotic dynamical system.

5. The reservoir computing device of claim 1, wherein the reservoir comprises a randomly parameterized network of nodes and recurrent links.

6. The reservoir computing device of claim 1, wherein the autonomous time-delay Boolean network comprises a plurality of autonomous logic elements.

7. The reservoir computing device of claim 1, wherein the reservoir is a recurrent artificial neural network.

8. The reservoir computing device of claim 1, wherein the reservoir comprises a plurality of interconnections, wherein each interconnection of the plurality of interconnections couples a pair of the plurality of the nodes.

9. The reservoir computing device of claim 1, wherein the at least one input signal is weighted.

10. The reservoir computing device of claim 1, wherein the at least one output signal is weighted.

11. The reservoir computing device of claim 1, wherein each of the plurality of nodes is weighted.

12. The reservoir computing device of claim 1, wherein the plurality of nodes implements at least one Boolean logic gate to perform at least one operation on the at least one input signal.

13. A reservoir computing device, comprising:
a reservoir comprising an autonomous time-delay Boolean network of nodes; and
a controller configured to provide input data to the reservoir and receive output data from the reservoir, wherein the reservoir and the controller are comprised in integrated circuitry and configured to provide time-series prediction.

14. The reservoir computing device of claim 13, wherein the integrated circuitry comprises a field-programmable gate array (FPGA).

15. The reservoir computing device of claim 13, further comprising a memory that stores the input data, the output data, and node data of the autonomous time-delay Boolean network of nodes.

16. The reservoir computing device of claim 15, further comprising a weighting module that applies weight to at least one of the input data, the output data, or the node data.

17. The reservoir computing device of claim 16, wherein the reservoir, the controller, the memory, and the weighting module are configured to predict a behavior of a chaotic dynamical system.

18. The reservoir computing device of claim 13, wherein the reservoir comprises a randomly parameterized network of nodes and recurrent links.

19. The reservoir computing device of claim 13, wherein the autonomous time-delay Boolean network comprises a plurality of autonomous logic elements.

20. The reservoir computing device of claim 13, wherein the reservoir comprises a plurality of interconnections, wherein each interconnection of the plurality of interconnections couples a pair of the nodes.
